(19) United States
(12) Patent Application Publication
(10) Pub. No.: US 2022/0204417 A1
(43) Pub. Date: Jun. 30, 2022

(54) PHOSPHOGYPSUM CONTAINING FERTILIZER GRANULES

(71) Applicant: SABIC Global Technologies B.V., Bergen op Zoom (NL)

(72) Inventors: Ravi HEGDE, Bangalore (IN); Satish BURLA, Bangalore (IN); Khalid AL ROHILY, Riyadh (SA)

(73) Assignee: SABIC Global Technologies B.V., Bergen op Zoom (NL)

(21) Appl. No.: 17/554,111

(22) Filed: Dec. 17, 2021

Related U.S. Application Data
(60) Provisional application No. 63/132,657, filed on Dec. 31, 2020.

(51) Int. Cl. C05B 17/00; C05G 5/12

(52) U.S. Cl. CPC C05B 17/00; C05G 5/12

(57) ABSTRACT

Disclosed is a fertilizer granule containing a homogeneous mixture containing i) phosphogypsum in an amount providing 6.5 wt. % to 22 wt. % of calcium (Ca) and 5 wt. % to 17.6 wt. % of sulfur (S) present in the form of sulfate, ii) 3.8 wt. % to 8 wt. % of magnesium (Mg), iii) 0.5 wt. % to 4 wt. % of zinc (Zn), iv) additional sulfate in an amount providing 5 to 12.5 wt. % of sulfur (S), and v) optionally 0.5 wt. % to 5 wt. % of a humic substance, based on the total weight of the fertilizer granule. Methods of making and using the fertilizer granule are also disclosed.

### CROSS REFERENCE TO RELATED APPLICATIONS

This application claims the benefit of priority to U.S. Provisional Patent Application Ser. No. 63/132,657, filed Dec. 31, 2020, hereby incorporated by reference in its entirety.

### BACKGROUND OF THE INVENTION

### A. Field of the Invention

The invention generally concerns fertilizer granules containing phosphogypsum. In particular, the invention concerns phosphogypsum containing fertilizer granules containing calcium, magnesium, zinc, and sulfur.

### B. Description of Related Art

Calcium (Ca), magnesium (Mg), zinc (Zn), boron (B), and sulfur (S) are important plant nutrients and are useful for achieving thriving agriculture and growth of plants. Upon repeated planting cycles, the quantity of these nutrients in the soil may be depleted, resulting in inhibited plant growth and decreased production. To counter this effect, fertilizers have been developed to help replace the depleted vital nutrients and to create the right balance of nutrients.

Attempts have been made to provide fertilizer composition containing Ca, Mg, Zn, B, and S. Gypsum is a commonly used source of Ca and S. For example, AU2009200226A1 discloses fertilizer compositions containing gypsum, where the fertilizer composition provides Ca, Mg, Zn, B, and S. However, gypsum has relatively low solubility and may not be readily accessible to plants.

### SUMMARY OF THE INVENTION

A solution to at least some of the problems discussed above has been discovered. In one aspect, the solution resides in providing a fertilizer granule containing calcium (Ca), magnesium (Mg), zinc (Zn), sulfur (S) present as sulfate, optionally boron (B), optionally a humic substance, and optionally a binder, where at least a portion of the Ca and a portion of the S is present as phosphogypsum. Phosphogypsum is a byproduct in phosphoric acid manufacturing industry. Phosphogypsum can contain calcium sulfate formed as a by-product from processing rock phosphate into phosphoric acid, by reacting rock phosphate with sulfuric acid.

Ca₅(PO₄)₃X+5 H₂SO₄+10 H₂O→3 H₃PO₄+5 CaSO₄.2 H₂O+HX

(where X may include OH, F, Cl, or Br).

Traditionally, phosphogypsum is a waste product that is stored in stacks on land, and/or is disposed in the sea. However, phosphogypsum has higher solubility in water than gypsum. This makes nutrients in phosphogypsum comparatively more accessible to plants compared to gypsum. Phosphogypsum can provide exchangeable Ca to ameliorate subsoil acidity and Al³⁺ toxicity, improve soil structure, soil aeration, and/or reclaim sodic soil and/or water use efficiency. Moreover, phosphogypsum can contain sufficient phosphorus in the form of, or to produce 0.5 wt. % to 3 wt. % of P₂O₅. Most, if not all P₂O₅ from phosphogypsum can be readily soluble in water, and can provide the important nutrient phosphorus to the plants. Phosphogypsum is also a cheaper source of Ca and S compared to gypsum. Thus, use of phosphogypsum in the fertilizer granules can be environmentally and economically beneficial.

One aspect of the present invention is directed to a fertilizer granule. The fertilizer granule can contain a homogeneous mixture containing calcium (Ca), magnesium (Mg), zinc (Zn), sulfur (S) present as sulfate, optionally boron (B), optionally a humic substance, and optionally a binder. In some aspects, the homogeneous mixture can contain i) phosphogypsum in an amount providing 6.5 wt. % to 22 wt. % of Ca, and 5 wt. % to 17.6 wt. % S present in the form of sulfate, ii) 3.8 wt. % to 8 wt. % of Mg, iii) 0.5 wt. % to 4 wt. % of Zn, iv) additional sulfate in an amount providing an additional 5 to 12.5 wt. % of S, and v) optionally 0.5 wt. % to 5 wt. % of a humic substance, based on the total weight of the homogeneous mixture and/or the fertilizer granule. Additional sulfate can refer to the sulfate in the homogeneous mixture other than the sulfate provided by phosphogypsum. The humic substance can contain humic acid and/or a humate salt. In certain aspects, the humate salt can be potassium humate. The homogeneous mixture can optionally contain 0.1 wt. % to 1 wt. % of boron (B), based on the total weight of the homogeneous mixture and/or the fertilizer granule. The homogeneous mixture can optionally contain 2 wt. % to 10 wt. % of a binder, based on the total weight of the homogeneous mixture and/or the fertilizer granule. In some particular aspects, the binder can be calcium lignosulfate and/or bentonite. The Mg can be sourced as a water soluble magnesium salt. In some aspects, the water soluble magnesium salt can be magnesium sulfate, such as magnesium sulfate monohydrate. The Zn can be sourced as a water soluble zinc salt. In some aspects, the water soluble zinc can be zinc sulfate, such as zinc sulfate monohydrate. The B can be sourced as a water soluble boron containing compound. In some aspects, the water soluble boron containing compound is a tetraborate and/or tetraborate salt. In certain aspects, the tetraborate salt can be disodium tetraborate, such as disodium tetraborate pentahydrate. The homogeneous mixture can contain “a” moles of Ca, “b” moles of Mg, “c” moles of Zn, and “d” moles of S, wherein d is≥0.8×(a+b+c), such as≥0.85×(a+b+c), such as d is≥0.9×(a+b+c), such as d is≥0.95×(a+b+c), where a, b, c, and d are positive real numbers. In some aspects, moisture content of the homogeneous mixture can be less than 1 wt. %, such as 0.1 wt. % to 0.9 wt. %. The moisture content can be, measured by drying the sample at 50 ° C., for 25 min and determining the amount of mass lost during drying. In some aspects, at least 90 wt. % of the Ca in the homogeneous mixture can be sourced and/or present as phosphogypsum, based on the total weight of Ca in the homogeneous mixture. Phosphogypsum can provide soluble phosphorus in the homogeneous mixture. In some aspects, the phosphogypsum can provide 0.1 wt. % to 2 wt. % of P₂O₅ in the homogeneous mixture, based on the total weight of the homogeneous mixture and/or the fertilizer granule.

In certain aspects, the homogeneous mixture can contain i) 15 wt. % to 20 wt. % of Ca, ii) 3.8 wt. % to 5 wt. % of Mg, iii) 0.5 wt. % to 2.5 wt. % of Zn, iv) 13 wt. % to 20 wt. % of S, present as sulfate, v) 0.5 to 3 wt. % of a humic substance, such as potassium humate, and vi) 0.1 wt. % to 0.4 wt. % of B, present as tetraborate, such as disodium tetraborate, based on the total weight of the homogeneous mixture and/or the fertilizer granule. In some aspects, at least 95% of the Ca in the homogeneous mixture can be sourced and/or present as phosphogypsum, based on the total weight of Ca in the homogeneous mixture. In certain aspects, the homogeneous mixture can contain i) 14 wt. % to 19 wt. % of Ca, ii) 4 wt. % to 6 wt. % of Mg, iii) 1 wt. % to 3 wt. % of Zn, iv) 13 wt. % to 20 wt. % of S, present as sulfate; and v) 1.5 to 4 wt. % of a humic substance, such as potassium humate, based on the total weight of the homogeneous mixture. In some aspects, at least 95% of the Ca in the homogeneous mixture can be sourced and/or present as phosphogypsum, based on the total weight of Ca in the homogeneous mixture. In certain aspects, the homogeneous mixture can contain i) 13 wt. % to 19 wt. % of Ca, ii) 4 wt. % to 6 wt. % of Mg, iii) 0.5 wt. % to 2.5 wt. % of Zn, iv) 13 wt. % to 20 wt. % of S, present as sulfate, v) 0.1 wt. % to 0.4 wt. % of B, present as tetraborate, such as disodium tetraborate, vi) 0.5 wt. % to 3 wt. % of a humic substance, such as potassium humate; and vii) 3 wt. % to 7 wt. % of bentonite, based on the total weight of the homogeneous mixture. In some aspects, at least 95% of the Ca in the homogeneous mixture can be sourced and/or present as phosphogypsum, based on the total weight of Ca in the homogeneous mixture. In certain aspects, the homogeneous mixture can contain i) 13 wt. % to 19 wt. % of Ca, ii) 4 wt. % to 6 wt. % of Mg, iii) 0.5 wt. % to 2.5 wt. % of Zn, iv) 13 wt. % to 20 wt. % of S, present as sulfate, v) 0.1 wt. % to 0.4 wt. % of B, present as tetraborate, such as disodium tetraborate, vi) 0.5 wt. % to 3 wt. % of a humic substance, such as potassium humate; and vii) 3 wt. % to 7 wt. % of calcium lignosulfate; and optionally viii) 3 wt. % to 7 wt. % of bentonite, based on the total weight of the homogeneous mixture. In some aspects, at least 90% of the Ca in the homogeneous mixture can be sourced and/or present as phosphogypsum, based on the total weight of Ca in the homogeneous mixture.

The homogeneous mixture can comprise 85 wt. % or greater, such as 90 wt. % or greater, such as 95 wt. % or greater, such as 97 wt. % or greater, such as 98 wt. % or greater, such as 99 wt. % or greater, such as 99.5 wt. % or greater, such as about 100 wt. % of the fertilizer granule. In some aspects, total wt.% of phosphogypsum, Mg, Zn, additional sulfate, optional boron (B), optional humic substance, and optional binder in the homogeneous mixture can be 70 wt. % or greater, such as 75 wt. % or greater, such as 80 wt. % or greater, such as 85 wt. % or greater, such as 90 wt. % or greater, such as 95 wt. % or greater, such as 97 wt. % or greater, such as 98 wt. % or greater, such as 99 wt. % or greater.

In some aspects, the fertilizer granule can have a crush strength above 1.5 kgf, such as above 1.8 kgf, such as 2 kgf to 6 kgf. In some aspects, the fertilizer granule is capable of losing less than 0.13 wt. %, such as 0.02% to 0.12% in an attrition loss test. Bulk density of the fertilizer granules can be 1 g/cc to 1.2 g/cc. In some aspects, 10 mg to 30 mg of the fertilizer granules can dissolve in 1 ml of water at a pH 7, under stirring at a rate 90 rpm to 110 rpm, at an ambient temperature, within 5 minutes of adding 100 mg of the fertilizer granules to the water. The physical properties of the granule, e.g., crush strength, attrition loss, and bulk density, can be measured according to the respective methods described in the examples.

Certain aspects, are directed to a composition containing the fertilizer granule. In some aspects, the fertilizer granule can be included in a fertilizer blend or a compounded fertilizer. The fertilizer blend or the compounded fertilizer in addition to the fertilizer granules can contain a second fertilizer. In some aspects, the second fertilizer can contain urea, monoammonium phosphate (MAP), diammonium phosphate (DAP), muriate of potash (MOP), monopotassium phosphate (MKP), triple super phosphate (TSP), rock phosphate, single super phosphate (SSP), or the like, or any combinations thereof.

The fertilizer granule can be of any suitable shape. In some aspects, the fertilizer granule can be spherical. In some aspects, the fertilizer granule can be of cylindrical shape with a circular, elliptical, ovular, triangular, square, rectangular, pentagonal, or hexagonal cross section, although a cylindrical shaped core having a cross-section of other shapes can also be made. In some aspects, the fertilizer granule can have a dimension such as length, width, height, and/or cross-sectional diameter between 0.5 mm to 6 mm. In some aspects, the fertilizer granule can have a substantially spherical shape with an average diameter 0.5 mm to 5 mm, preferably 1 mm to 4 mm.

One aspect is directed to a method of making a fertilizer granule described herein. The method can include steps a) and/or b). In step a) a feed mixture can be contacted with water, and can be granulated to form a wet granulated mixture. In step b) the wet granulated mixture can be dried to form a dry granulated mixture containing the fertilizer granule. The feed mixture can contain Ca, Mg, Zn, sulfate, and optionally B, optionally a humic substance, and optionally a binder. At least a portion of the Ca and a portion of S in the feed mixture can be present as phosphogypsum. In some aspects, the feed mixture can contain i) phosphogypsum, ii) magnesium sulfate, iii) zinc sulfate, iv) optionally a borate, such as disodium tetraborate, v) optionally a humic substance, such as potassium humate, and vii) optionally a binder, such as bentonite and/or calcium lignosulfate. In certain aspects, 5 gm to 20 gm, of water can be added per 100 gm of feed mixture. The water can be added to the feed mixture with one or more feed mixture ingredients, e.g., as aqueous binder solution, and/or separately. In some aspects, the feed mixture can be granulated by compaction. In certain aspects, the wet granulated mixture, prior to drying, can be passed through one or more size screens to separate granules having a size smaller and/or bigger than a desired size; and at least a portion of the separated granules can be recycled to the granulation step. In certain aspects, at least a portion of the separated granules having a size bigger than the desired size, can be crushed/ground and recycled to the granulation step. In certain aspects, granules in the wet granulated mixture can be spheronized. In some particular aspects, granules in the wet granulated mixture can be spheronized prior to passing the wet granulated mixture through the one or more size screens and/or prior to drying the granules.

One aspect of the present invention is directed to a method of fertilizing, the method comprising applying a fertilizer granule, a fertilizer composition containing the fertilizer granule, and/or a fertilizer blend containing the fertilizer granule described herein to at least a portion of a soil, a crop, or the soil and the crop. Also disclosed is a method of enhancing plant growth comprising applying to soil, the plant, or the soil and the plant an effective amount of a composition comprising a fertilizer blend of the present invention.

Also disclosed are the following Aspects 1 to 20 of the present invention.

Aspect 1 is a fertilizer granule comprising a homogeneous mixture comprising: phosphogypsum in an amount providing 6.5 wt. % to 22 wt. % of calcium (Ca) and 5 wt. % to 17.6 wt. % sulfur (S) present in the form of sulfate; 3.8 wt. % to 8 wt. % of magnesium (Mg); 0.5 wt. % to 4 wt. % of zinc (Zn); additional sulfate in an amount providing an additional 5 to 12.5 wt. % of sulfur (S); and optionally 0.5 wt. % to 5 wt. % of a humic substance, wherein the wt. % are based on the total weight of the fertilizer granule.

Aspect 2 is the fertilizer granule of Aspect 1, further comprising 0.1 wt. % to 1 wt. % of boron (B).

Aspect 3 is the fertilizer granule of any one of Aspects 1 to 2, further comprising 2 wt. % to 10 wt. % of a binder.

Aspect 4 is the fertilizer granule of Aspect 3, wherein the binder is calcium lignosulfate and/or bentonite.

Aspect 5 is the fertilizer granule of any one of Aspects 1 to 4, wherein the humic substance comprises humic acid and/or a humate salt, preferably potassium humate.

Aspect 6 is the fertilizer granule of any one of Aspects 1 to 5, wherein the Mg is sourced as a water soluble magnesium sulfate, preferably magnesium sulfate monohydrate and/or the Zn is sourced as a water soluble zinc sulfate, preferably zinc sulfate monohydrate.

Aspect 7 is the fertilizer granule of any one of Aspects 2 to 6, wherein the B is sourced as a water soluble tetraborate and/or tetraborate salt, preferably disodium tetraborate pentahydrate.

Aspect 8 is the fertilizer granule of any one of Aspects 1 to 7, comprising a moles of Ca, b moles of Mg, c of moles Zn, and d moles of S, wherein d is≥0.9×(a+b+c) and a, b, c, and d are real numbers.

Aspect 9 is the fertilizer granule of any one of Aspects 2 to 8, comprising 15 wt. % to 20 wt. % of calcium (Ca); 3.8 wt. % to 5 wt. % of magnesium (Mg); 0.5 wt. % to 2.5 wt. % of zinc (Zn); 13 wt. % to 20 wt. % of sulfur (S); 0.5 to 3 wt. % of a humic substance; and 0.1 wt. % to 0.4 wt. % of B.

Aspect 10 is the fertilizer granule of any one of Aspects 1 to 8, comprising 14 wt. % to 19 wt. % of calcium (Ca); 4 wt. % to 6 wt. % of magnesium (Mg); 1 wt. % to 3 wt. % of zinc (Zn); 13 wt. % to 20 wt. % of sulfur (S); and 1.5 to 4 wt. % of a humic substance.

Aspect 11 is the fertilizer granule of any one of Aspects 2 to 8, comprising 13 wt. % to 19 wt. % of calcium (Ca); 4 wt. % to 6 wt. % of magnesium (Mg); 0.5 wt. % to 2.5 wt. % of zinc (Zn); 13 wt. % to 20 wt. % of sulfur (S); 0.1 wt. % to 0.4 wt. % of B; 0.5 wt. % to 3 wt. % of a humic substance; and either 3 wt. % to 7 wt. % of bentonite, or 3 wt. % to 7 wt. % of calcium lignosulfate, or both 3 wt. % to 7 wt. % of bentonite and 3 wt. % to 7 wt. % of calcium lignosulfate.

Aspect 12 is the fertilizer granule of any one of Aspects 1 to 11, wherein 10 mg to 30 mg of the fertilizer granules dissolves in 1 ml of water at a pH 7, under stirring at a rate 90 rpm to 110 rpm, and at an ambient temperature, within 5 minutes of adding 100 mg of the fertilizer granules to the water.

Aspect 13 is the fertilizer granule of any one of Aspects 1 to 12, having a moisture content of less than 1 wt. %, preferably 0.1 wt. % to 0.9 wt. %, measured at 50° C.

Aspect 14 is the fertilizer granule of any one of Aspects 1 to 13, having a crush strength above 1.8 kgf, preferably 2 kgf to 6 kgf.

Aspect 15 is the fertilizer granule of any one of Aspects 1 to 14, capable of losing less than 0.13 wt. %, preferably 0.02% to 0.12% in an attrition loss test.

Aspect 16 is the fertilizer granule of any one of Aspects 1 to 15, wherein the granules have a bulk density of 1 g/cc to 1.2 g/cc.

Aspect 17 is the fertilizer granule of any one of Aspects 1 to 16, comprised in a fertilizer blend comprising the fertilizer granule and an additional fertilizer comprising urea, diammonium phosphate (DAP), single super phosphate (SSP), triple super phosphate (TSP), muriate of potash (MOP), ammonium sulfate, or any combinations thereof.

Aspect 18 is a method for making the fertilizer granule of any one of Aspects 1 to 17, the method comprising: contacting a feed mixture with water and granulating the feed mixture to form a wet granulated mixture, wherein the feed mixture comprises Ca, Mg, Zn, sulfate, and optionally B, optionally humic acid, and optionally a binder; and drying the wet granulated mixture to form a dry granulated mixture comprising the fertilizer granule.

Aspect 19 is the method of Aspect 18, wherein the feed mixture is granulated by compaction.

Aspect 20 is the method of any one of Aspects 18 or 19, further comprising: passing the wet granulated mixture, prior to drying, through one or more size screens to separate granules having a size smaller and/or bigger than a desired size; and recycling at least a portion of the separated granules to the granulation step.

In the context of the present invention, fertilizer granules and/or fertilizer blend granules may also be referred to as a particle, granule, fertilizer particle, prill, or fertilizer prill.

The term “fertilizer” is defined as a material applied to soils or to plant tissues to supply one or more plant nutrients essential or beneficial to the growth of plants and/or stimulants or enhancers to increase or enhance plant growth.

The term “granule” can include a solid material. A granule can have a variety of different shapes, non-limiting examples of which include a spherical, a puck, an oval, a rod, an oblong, or a random shape.

The term “particle” can include a solid material less than a millimeter in its largest dimension.

The terms “particulate” or “powder” can include a plurality of particles.

The terms “aqueous based,” “aqueous base,” “water based,” and “water base” are defined as containing water or was previously contained in water before drying.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting,” or “reducing,” or “preventing,” or “avoiding,” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, A, B, and/or C can include: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings. While the invention is susceptible to various modifications and alternative forms, specific embodiments thereof are shown by way of example in the drawings. The drawings may not be to scale.

FIG. 1: Example cross-sectional view of a fertilizer granule according to a non-limiting example of a fertilizer granule described herein.

FIG. 2: a schematic of a system and method for producing a fertilizer granule according to a non-limiting example of a system and method disclosed herein.

FIG. 3: a schematic of a system and method for producing a fertilizer granule according to another non-limiting example of a system and method disclosed herein.

FIG. 4A and B: Soil dispersibility of urea and PG-22 granules.

FIG. 5: Water dispersibility of PG-22 granules.

FIG. 6: Granules of SUL4R-PLUS® (A) and PGG-1 (B).

FIG. 7A and B: Soil dispersibility of SUL4R-PLUS®, PGG-1, PGG-3, and PGG-4 granules.

FIG. 8: Water dispersibility of SUL4R-PLUS® (A), PGG-1(B), PGG-3 (C), and PGG-4 (D) granules.

### DETAILED DESCRIPTION OF THE INVENTION

The fertilizer granule of the present invention can contain calcium (Ca), magnesium (Mg), zinc (Zn), sulfur (S) present as sulfate, optionally boron (B), optionally a humic substance, and optionally a binder, where at least a portion of the Ca and a portion of the S is present as phosphogypsum. As illustrated in a non-limiting manner in the Examples, it was found that fertilizer granules of the present invention can have good soil and water dispersibility and can also provide water soluble phosphorus to improve plant growth.

These and other non-limiting aspects of the present invention are discussed in further detail in the following sections.

### A. Fertilizer Granules

The fertilizer granule can contain a homogeneous mixture containing calcium (Ca), magnesium (Mg), zinc (Zn), sulfur (S) present as sulfate, optionally boron (B), optionally a humic substance, and optionally a binder. At least a portion of Ca can be present as phosphogypsum. In some aspects, at least 90 wt. %, or at least 95 wt. %, or 90 wt. % to 100 wt. %, or at least any one of, at most any one of, equal to any one of, or between any two of 90, 91, 92, 93, 94, 95, 96, 97, 98, 99, 99.5, and 100 wt. % of the Ca in the homogeneous mixture can be present as phosphogypsum, based on the total weight of Ca in the homogeneous mixture. In some aspects, homogeneous mixture can contain i) phosphogypsum in an amount providing 6.5 wt. % to 22 wt. % of, or at least any one of, at most any one of, equal to any one of, or between any two of 6.5, 7, 8, 9, 10, 11, 12, 13, 14, 15, 16, 17, 18, 19, 20, 21, and 22 wt. % of Ca, and 5 wt. % to 17.6 wt. % , or at least any one of, at most any one of, equal to any one of, or between any two of 5, 6, 7, 8, 9, 10, 11, 12, 13, 14, 15, 16, 17, and 17.6 wt. % of S present in the form of sulfate, ii) 3.8 wt. % to 8 wt. %, or at least any one of, at most any one of, equal to any one of, or between any two of 3.8, 4, 4.5, 5, 5.5, 6, 6.5, 7, 7.5, and 8 wt. % of Mg, iii) 0.5 wt. % to 4 wt. %, or at least any one of, at most any one of, equal to any one of, or between any two of 0.5, 1, 1.5, 2, 2.5, 3, 3.5, and 4 wt. % of Zn, iv) additional sulfate in an amount providing an additional 5 to 12.5 wt. %, or at least any one of, at most any one of, equal to any one of, or between any two of 5, 6, 7, 8, 9, 10, 11, 12, and 12.5 wt. % of S, v) optionally 0.5 wt. % to 5 wt. %, or at least any one of, at most any one of, equal to any one of, or between any two of 0.5, 1, 1.5, 2, 2.5, 3, 3.5, 4, 4.5, and 5 wt. % of a humic substance, vi) optionally 0.1 wt. % to 1 wt. %, or at least any one of, at most any one of, equal to any one of, or between any two of 0.1, 0.2, 0.3, 0.4, 0.5, 0.6, 0.7, 0.8, 0.9, and 1 wt. % of boron, and vii) optionally 2 wt. % to 10 wt. %, or at least any one of, at most any one of, equal to any one of, or between any two of 2, 3, 4, 5, 6, 7, 8, 9, and 10 wt. % of a binder, based on the total weight of the homogeneous mixture and/or the fertilizer granule. Phosphogypsum can also provide 0.1 wt. % to 2 wt. %, or at least any one of, at most any one of, equal to any one of, or between any two of 0.1, 0.2, 0.4, 0.6, 0.8, 1, 1.2, 1.4, 1.6, 1.8, and 2 wt. % of P₂O₅ in the homogeneous mixture, based on the total weight of the homogeneous mixture and/or the fertilizer granule.

The humic substance can contain decomposed or partially decomposed organisms, humic acids, fulvic acids, humin, humus, and/or a humate salt. In certain aspects, the humate salt can be potassium humate. Potassium humate can provide organic carbon, increase other plant nutrient uptake, increase water use efficiency, increase soil microbial population and/or improves soil structure.

In some particular aspects, the binder can be calcium lignosulfate, bentonite, gum acacia, a phosphate, a polyphosphate, a biodegradable polymer, a wax, Plaster of Paris, flour, starch, or gluten, or a combination thereof. In some particular aspects, the binder can be calcium lignosulfate and/or bentonite. Calcium lignosulfate can help in dispersibility of the fertilizer granule in soil and water, as it is soluble in water, can provide organic carbon, and can increase other plant nutrient uptake by complexation mechanism. Bentonite can also function as a swelling agent and may also help in dispersibility of the fertilizer granule in soil and/or water.

The Mg, Zn, and/or B can be present as and/or sourced as a water soluble compound or a water insoluble compound. In some instances, the Mg, Zn, and/or B can be present as a salt. In some aspects, the Mg, Zn, and/or B can be present as a water soluble salt. In some instances, the water soluble magnesium salt can be magnesium sulfate. In some aspects, the water soluble zinc salt can be zinc sulfate. In some instances, the B can be present as a B salt, tetraborate, or tetraborate salt. The B can be sourced as a water soluble tetraborate and/or tetraborate salt. The Mg, Zn, and/or B salt can be in a non-hydrate and/or one or more hydrate form. Magnesium sulfate, zinc sulfate, and/or disodium tetraborate independently can be present and/or sourced as non-hydrate and/or one or more hydrates. In some instances, the magnesium sulfate is sourced as a magnesium sulfate monohydrate, the zinc sulfate is sourced as a zinc sulfate monohydrate, and/or the disodium tetraborate is sourced as a disodium tetraborate pentahydrate.

Moisture content of the fertilizer granule can be less than 1 wt. %, such as 0.1 wt. % to 0.9 wt. %, or any one of or between any two of 0.1, 0.2, 0.3, 0.4, 0.5, 0.6, 0.7, 0.8, 0.9, or 1 wt. %, or any range thereof, based on the weight of the fertilizer granule. As a non-limiting example, the moisture content can be measured by drying the sample at 50° C., for 25 min and measuring the amount of mass lost by the fertilizer after being dried.

In some particular aspects, the homogeneous mixture can contain and/or can be obtained from phosphogypsum, magnesium sulfate, potassium humate, zinc sulfate, and disodium tetraborate, wherein i) Ca content of the homogeneous mixture can be 15 wt. % to 20 wt. %, or at least any one of, at most any one of, equal to any one of, or between any two of 15, 16, 17, 18, 19, and 20 wt. %, ii) Mg content of the homogeneous mixture can be 3.8 wt. % to 5 wt. %, or at least any one of, at most any one of, equal to any one of, or between any two of 3.8, 4, 4.2, 4.4, 4.6, 4.8, and 5 wt. %, iii) Zn content of the homogeneous mixture can be 0.5 wt. % to 2.5 wt. %, or at least any one of, at most any one of, equal to any one of, or between any two of 0.5, 0.7, 0.9, 1.1, 1.3, 1.5, 1.7, 1.9, 2.1, 2.3, and 2.5 wt. %, iv) S content of the homogeneous mixture can be 13 wt. % to 20 wt. %, or at least any one of, at most any one of, equal to any one of, or between any two of 13, 14, 15, 16, 17, 18, 19, and 20 wt. %, v) potassium humate content of the homogeneous mixture can be 0.5 to 3 wt. %, or at least any one of, at most any one of, equal to any one of, or between any two of 0.5, 0.7, 0.9, 1.1, 1.3, 1.5, 1.7, 1.9, 2.1, 2.3, 2.5, 2.7, 2.9, and 3 wt. %, and vi) B content of the homogeneous mixture can be 0.1 wt. % to 0.4 wt. %, or at least any one of, at most any one of, equal to any one of, or between any two of 0.1, 0.15, 0.2, 0.25, 0.3, 0.35, and 0.4 wt. %, based on the total weight of the homogeneous mixture and/or fertilizer granule. In some particular aspects, at least 95%, or at least any one of, equal to any one of, or between any two of 95, 96, 97, 98, 99 and 100 wt. % of the Ca in the homogeneous mixture can be sourced and/or present as phosphogypsum, based on the total weight of Ca in the homogeneous mixture.

In some particular aspects, the homogeneous mixture can contain and/or can be obtained from phosphogypsum, magnesium sulfate, potassium humate, and zinc sulfate, wherein i) Ca content of the homogeneous mixture can be 14 wt. % to 19 wt. %, or at least any one of, at most any one of, equal to any one of, or between any two of 14, 15, 16, 17, 18, and 19 wt. %, ii) Mg content of the homogeneous mixture can be 4 wt. % to 6 wt. %, or at least any one of, at most any one of, equal to any one of, or between any two of 4, 4.2, 4.4, 4.6, 4.8, 5, 5.2, 5.4, 5.6, 5.8, and 6 wt. %, iii) Zn content of the homogeneous mixture can be 1 wt. % to 3 wt. %, or at least any one of, at most any one of, equal to any one of, or between any two of 1, 1.1, 1.3, 1.5, 1.7, 1.9, 2.1, 2.3, 2.5, 2.7, 2.9, and 3 wt. %, iv) S content of the homogeneous mixture can be 13 wt. % to 20 wt. %, or at least any one of, at most any one of, equal to any one of, or between any two of 13, 14, 15, 16, 17, 18, 19, and 20 wt. %, and vi) potassium humate content of the homogeneous mixture can be 1.5 to 4 wt. %, or at least any one of, at most any one of, equal to any one of, or between any two of 1.5, 1.7, 1.9, 2.1, 2.3, 2.5, 2.7, 2.9, 3.1, 3.3, 3.5, 3.7, 3.9, and 4 wt. %, based on the total weight of the homogeneous mixture. In some particular aspects, at least 95%, or at least any one of, equal to any one of, or between any two of 95, 96, 97, 98, 99, and 100 wt. % of the Ca in the homogeneous mixture can be sourced and/or present as phosphogypsum, based on the total weight of Ca in the homogeneous mixture.

In some particular aspects, the homogeneous mixture can contain and/or can be obtained from phosphogypsum, magnesium sulfate, potassium humate, zinc sulfate, disodium tetraborate, and bentonite, wherein i) Ca content of the homogeneous mixture can be 13 wt. % to 19 wt. %, or at least any one of, at most any one of, equal to any one of, or between any two of 13, 14, 15, 16, 17, 18, and 19 wt. %, ii) Mg content of the homogeneous mixture can be 4 wt. % to 6 wt. %, or at least any one of, at most any one of, equal to any one of, or between any two of 4, 4.2, 4.4, 4.6, 4.8, 5, 5.2, 5.4, 5.6, 5.8, and 6 wt. %, iii) Zn content of the homogeneous mixture can be 0.5 wt. % to 2.5 wt. %, or at least any one of, at most any one of, equal to any one of, or between any two of 0.5, 0.7, 0.9, 1.1, 1.3, 1.5, 1.7, 1.9, 2.1, 2.3, and 2.5 wt. %, iv) S content of the homogeneous mixture can be 13 wt. % to 20 wt. %, or at least any one of, at most any one of, equal to any one of, or between any two of 13, 14, 15, 16, 17, 18, 19, and 20 wt. %, v) potassium humate content of the homogeneous mixture can be 0.5 to 3 wt. %, or at least any one of, at most any one of, equal to any one of, or between any two of 0.5, 0.7, 0.9, 1.1, 1.3, 1.5, 1.7, 1.9, 2.1, 2.3, 2.5, 2.7, 2.9, and 3 wt. %, vi) B content of the homogeneous mixture can be 0.1 wt. % to 0.4 wt. %, or at least any one of, at most any one of, equal to any one of, or between any two of 0.1, 0.15, 0.2, 0.25, 0.3, 0.35, and 0.4 wt. %, and vii) bentonite content of the homogeneous mixture can be 3 wt. % to 7 wt. %, or at least any one of, at most any one of, equal to any one of, or between any two of 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, and 7 wt. %, based on the total weight of the homogeneous mixture. In some particular aspects, at least 95%, or at least any one of, equal to any one of, or between any two of 95, 96, 97, 98, 99, and 100 wt. % of the Ca in the homogeneous mixture can be sourced and/or present as phosphogypsum, based on the total weight of Ca in the homogeneous mixture.

In some particular aspects, the homogeneous mixture can contain and/or can be obtained from phosphogypsum, magnesium sulfate, potassium humate, zinc sulfate, disodium tetraborate, and calcium lignosulfate, and optionally bentonite, wherein i) Ca content of the homogeneous mixture can be 13 wt. % to 19 wt. %, or at least any one of, at most any one of, equal to any one of, or between any two of 13, 14, 15, 16, 17, 18, and 19 wt. %, ii) Mg content of the homogeneous mixture can be 4 wt. % to 6 wt. %, or at least any one of, at most any one of, equal to any one of, or between any two of 4, 4.2, 4.4, 4.6, 4.8, 5, 5.2, 5.4, 5.6, 5.8, and 6 wt. %, iii) Zn content of the homogeneous mixture can be 0.5 wt. % to 2.5 wt. %, or at least any one of, at most any one of, equal to any one of, or between any two of 0.5, 0.7, 0.9, 1.1, 1.3, 1.5, 1.7, 1.9, 2.1, 2.3, and 2.5 wt. %, iv) S content of the homogeneous mixture can be 13 wt. % to 20 wt. %, or at least any one of, at most any one of, equal to any one of, or between any two of 13, 14, 15, 16, 17, 18, 19, and 20 wt. %, v) potassium humate content of the homogeneous mixture can be 0.5 to 3 wt. %, or at least any one of, at most any one of, equal to any one of, or between any two of 0.5, 0.7, 0.9, 1.1, 1.3, 1.5, 1.7, 1.9, 2.1, 2.3, 2.5, 2.7, 2.9, and 3 wt. %, vi) B content of the homogeneous mixture can be 0.1 wt. % to 0.4 wt. %, or at least any one of, at most any one of, equal to any one of, or between any two of 0.1, 0.15, 0.2, 0.25, 0.3, 0.35, and 0.4 wt. %, and vii) calcium lignosulfate content of the homogeneous mixture can be 3 wt. % to 7 wt. %, or at least any one of, at most any one of, equal to any one of, or between any two of 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, and 7 wt. %, based on the total weight of the granule, and optionally vii) bentonite content of the homogeneous mixture can be 3 wt. % to 7 wt. %, or at least any one of, at most any one of, equal to any one of, or between any two of 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, and 7 wt. %. In some particular aspects, at least 90%, or at least any one of, equal to any one of, or between any two of 90, 91, 92, 93, 94, 95, 96, 97, 98, and 99 wt. % of the Ca in the homogeneous mixture can be sourced and/or present as phosphogypsum, based on the total weight of Ca in the homogeneous mixture.

The fertilizer granule can be of any suitable shape. Non-limiting shapes include spherical, cuboidal, cylindrical, puck shape, oval, and oblong shapes. In some aspects, the fertilizer granule can be of cylindrical shape with a circular, elliptical, ovular, triangular, square, rectangular, pentagonal, or hexagonal cross section, although cylindrical shaped core having a cross-section of other shapes can also be made. In some aspects, the fertilizer granule at its widest dimension can be 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm. In some particular aspects, the fertilizer granule can have a substantially spherical shape with an average diameter 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm.

The fertilizer granule can be water and/or soil dispersible. In some aspects, a fertilizer granule having a size of 2 mm to 4 mm prior to adding to water, can disintegrate into particles having sizes less than 1 mm, less than 0.9 mm, less than 0.8 mm, less than 0.7 mm, less than 0.6 mm, less than 0.5 mm, less than 0.4 mm, or less than 0.3 mm, within 1 minute of adding the granule to water at a pH 7, under stirring at a rate 90 rpm to 110 rpm, at an ambient temperature.

The homogeneous mixture can have a compositional make-up that is substantially homogeneous. In some instances, a compositional make-up for a 1 mm×1 mm×1 mm cube at any position of the mixture can be similar (within ±20%, or ±10%, or ±5%, or ±3%, ±2%, or ±1%, or ±0.5%) to that of a 1 mm×1 mm×1 mm cube at any other position of the mixture.

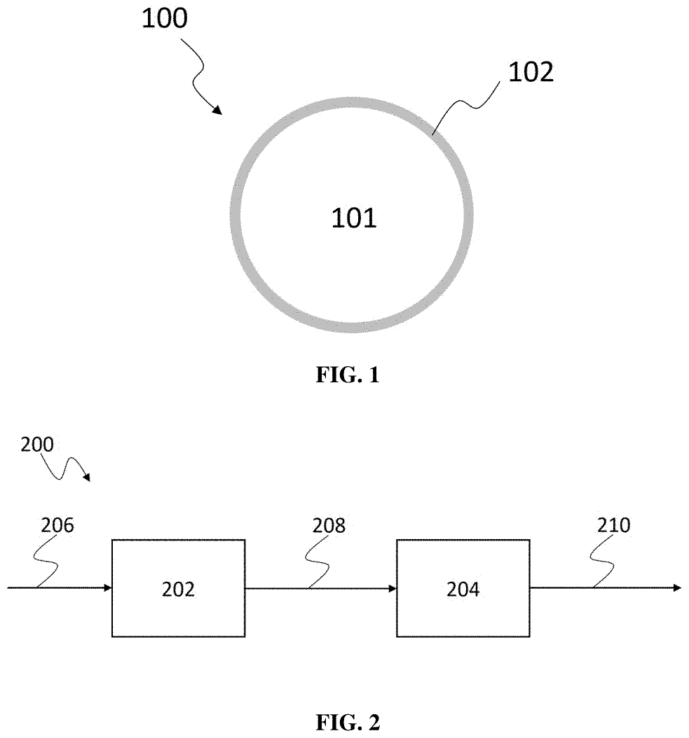

Referring to FIG. 1, a fertilizer granule 100 according to one example of the present invention is shown. The fertilizer granule 100 can contain an homogeneous mixture 101. The homogeneous mixture 101 can have compositions as described above. In some instances, the homogenous mixture 101 can have an optional coating 102 on the outer surface of the homogenous mixture 101.

In some aspects, additional fertilizer substances can be included or excluded in the fertilizer granules. If included, additional fertilizers can be chosen based on the particular needs of certain types of soil, climate, or other growing conditions to maximize the efficacy of the fertilizer granule in enhancing plant growth and crop yield. Additional additives may also be included or excluded in the fertilizer granules. Non-limiting examples of additives that can be included or excluded from the fertilizer granules of the present invention include nitrogen nutrients, phosphorus nutrients, potassium nutrients, additional micronutrients, and/or additional secondary nutrients. The micronutrient can be copper, iron, chloride, manganese, molybdenum, or nickel, or any combinations thereof. The nitrogen nutrient can be urea, ammonium nitrate, ammonium sulfate, diammonium phosphate, monoammonium phosphate, urea-formaldehyde, ammonium chloride, and potassium nitrate. In some aspects, the additional secondary nutrients may include lime and/or superphosphate. In some instances, the additional fertilizer substances and/or the additional additives are contained in the optional coating of the fertilizer granule.

The fertilizer granules described herein can be comprised in a composition useful for application to soil. In some aspects, in addition to the fertilizer granules, the composition may include other fertilizer compounds, micronutrients, primary nutrients, additional urea, additional nitrogen nutrients, insecticides, herbicides, or fungicides, or combinations thereof. The fertilizer granules described herein can also be included in a blended composition comprising other fertilizers. The other fertilizer can be urea, monoammonium phosphate (MAP), diammonium phosphate (DAP), muriate of potash (MOP), monopotassium phosphate (MKP), triple super phosphate (TSP), rock phosphate, single super phosphate (SSP), ammonium sulfate, and the like.

The fertilizer granules can have desirable physical properties such as desired levels of abrasion resistance, granule strength, pelletizability, hygroscopicity, granule shape, and size distribution. In some aspects, The fertilizer granule can have a crush strength above 1.5 kgf, such as above 1.8 kgf, such as 2 kgf to 6 kgf, or at least any one of, equal to any one of, or between any two of 2, 2.5, 3, 3.5, 4, 4.5, 5, 5.5, and 6 kgf. Bulk density of the fertilizer granules can be 1 g/cc to 1.2 g/cc, or at least any one of, at most any one of, equal to any one of, or between any two of 1, 1.02, 1.04, 1.06, 1.08, 1.1, 1.12, 1.14, 1.16, 1.18, and 1.2 g/cc. In some aspects, 10 mg or more, such as 10 mg to 40 mg, or at least any one of, at most any one of, equal to any one of, or between any two of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 mg of the fertilizer granule can dissolve in 1 ml of water at a pH 7, under stirring at a rate 90 to 110 rpm, and at an ambient temperature, within 5 minutes of adding 100 mg of the fertilizer granules to the water. In some aspects, the fertilizer granule is capable of losing less than 0.13 wt. %, such as 0.02% to 0.12 wt. %, or at most any one of, equal to any one of, or between any two of 0.02, 0.03, 0.04, 0.05, 0.06, 0.07, 0.08, 0.09, 0.1, 0.11, and 0.12 wt. % in an attrition loss test. Attrition loss can be measured using the following attrition loss test.

Attrition loss test: A plurality of sieved fertilizer granules with individual size 2 to 4 mm, and total volume 100 cm³ is weighed (W1) and is placed into the test drum along with the 50 stainless steel balls having a total weight of 100 gm. The drum is closed and rotated for 10 min at 30 rpm. Then, the steel balls are separated from the sample and the material is screened over 2 mm sieve using a sieve shaker. The total weight of the granules over 2 mm are then re-weighed (W2). Results are calculated in terms of % weight loss using the formula:

$$Weight loss due to attrition ( wt . \% ) = \frac{weight of sample remained on 2 mm sieve ( ( W 2 ) )}{intial weight of the sample ( W 1 )} \times 100$$

### B. Method of Making a Fertilizer Granule

Referring to FIG. 2, a schematic of a system and method for making a fertilizer granule according to one example of the present invention is described. The system 200 can include a granulator 202 and a dryer 204. A feed mixture 206 can be granulated in the granulator 202 in the presence of water to form a wet granulated mixture 208. The water can be provided with the feed mixture 206, and/or can be added separately to the granulator 202. The wet granulated mixture 208 can be dried in the dryer 204 to obtain dry granulated mixture 210 containing the fertilizer granule.

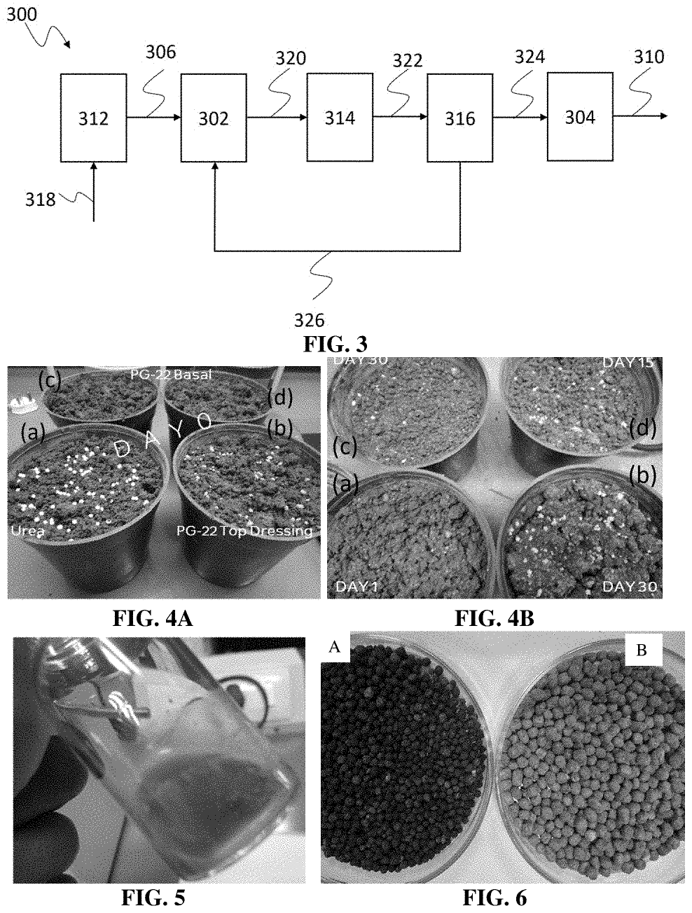

Referring to FIG. 3, a schematic of a system and method for making a fertilizer granule according to another example of the present invention is described. The system 300 can include a mixer 312, a granulator 302, a spheronizer 314, one or more size screens 316, and a dryer 304. The feed mixture ingredients 318, separately and/or at any possible combination can be added to the mixer 312. In the mixer 312, the feed mixture ingredients can be mixed to form the feed mixture 306. Feed mixture 306 can be granulated in the granulator 302 in presence of water to form a wet granulated mixture 320. Granules of the wet granulated mixture 320 can be spheronized in the spheronizer 314 to form a wet granulated mixture 322 containing substantially spherical granules. The wet granulated mixture 322 can be passed through one or more size screens 316 to separate granules having a size smaller or bigger than a desired size from the wet granulated mixture 322 and obtain a wet granulated mixture 324 containing granules of desired size. At least a portion of the granules separated 326 from the granulation mixture 324 containing granules of desired size can be recycled to the granulator 302. The wet granulated mixture 324 can be dried in the dryer 304 to obtain dry granulated mixture 310 containing the fertilizer granule. In some aspects, the mixer 312 can be a ribbon mixer.

The feed mixture ingredients 318 can include i) a Ca source, e.g., phosphogypsum, ii) a Mg source, e.g., a Mg salt, iii) a Zn source, e.g., a Zn salt, iv) optional a B source, e.g., a borate, v) optionally a humic substance such as potassium humate, and vi) optionally a binder, such as bentonite and/or calcium lignosulfate. Phosphogypsum, the Mg salt, and/or the Zn salt can also provide S, e.g., as sulfate in the feed mixture. In some instances, a mixture ingredient provides more than one of Ca, Mg, Zn, B, and/or a humic substance. In certain aspects, one or more ingredients, such as the binder can be added as a water solution. In some instances, the mixture ingredients are provided as a powder.

The feed mixture 206, 306 can contain Ca, Mg, Zn, sulfate, optionally B, optionally a humic substance, and optionally a binder. In some aspects, the feed mixture 206, 306 can contain i) phosphogypsum, ii) magnesium sulfate, iii) zinc sulfate, iv) optionally a borate, such as disodium tetraborate, v) optionally a humic substance, such as potassium humate, and vii) optionally a binder such as bentonite and/or calcium lignosulfate.

Water can be added to the feed mixture in the mixer 312 and/or in the granulator 202, 302. In certain aspects, 5 gm to 20 gm, or at least any one of, at most any one of, equal to any one of, or between any two 5, 6, 7, 8, 9, 10, 11, 12, 13, 14, 15, 16, 17, 18, 19, and 20 gm of water in total (e.g., added with one or more feed mixture ingredients and/or separately) can be added to the feed mixture, per 100 gm of feed mixture.

In some aspects, the granulator 202, 302 can be a drum granulator, pugmill granulator, pan granulator, solid mixer, abrasion drum, extruder, high-shear mixer granulator, roller granulator, mycromix, or a round bottom flask. In the granulator 202, 302 the feed mixture 206, 306 can be granulated by agglomeration, spray granulation, compaction, slurry granulation and/or high-shear mixer granulation. In some particular aspect, the feed mixture 206, 306 can be granulated in the granulator 202, 302 by compaction. In some aspects, the granulator 202, 302 can contain at least two rollers and compaction granulation can include compressing the feed mixture using the at least two rollers. In some aspects, the two rollers can be moved in counter current direction during compaction. In some aspects, the feed mixture can be compressed into shaped pellets, such as cylindrical pellets, by the at least two rollers. In some aspects, a surface of one roller can have desired holes to compress the feed mixture into the holes, and the surface of the other roller can push the feed mixture into the holes. Pressure during granulation, e.g. compaction granulation can be 5 bar to 40 bar, or at least any one of, at most any one of, equal to any one of, or between any two 5, 10, 15, 20, 25, 30, 35, and 40 bar. In certain aspects, the feed mixture can be granulated in the granulator 202, 302 at ambient temperature to 50° C., or at least any one of, at most any one of, equal to any one of, or between any two of −20, −15, −10, 0, 5, 10, 15, 20, 25, 30, 35, 40, 45 and 50° C.

In some aspects, mixing of the feed mixture ingredients and granulating the feed mixture can be performed in different containers, e.g., the mixer 312 and the granulator 302 can be different containers. In some aspects, mixing of the feed mixture ingredients and granulating the feed mixture can be performed in the same container, e.g., the mixer 312 and the granulator 302 can be the same container (not shown).

In certain aspect, the desired size can be 0.5 to 5 mm, or 1 to 4 mm, and granules having a size lower than 0.5 mm or 1 mm, and/or granules having a size bigger than 4 mm or 5 mm can be separated from the wet granulated mixture 322 in the one or more size screens 316. In certain aspects, the wet granulated mixture can be rounded and/or spheronized in a spheronizer. In some instances, the wet granulated mixture is contacted with a spheronizer for at least any one of, at most any one of, equal to any one of, or between any two of 5, 10, 15, 20, 25, 30, 35, 40, 50, or 60 seconds. The spheronizer in some instances has a rotating or rotatable disk capable of rotating at at least any one of, at most any one of, equal to any one of, or between any two of 200, 500, 1000, 1500, 2000, 2500, 3000, 3500, 4000, 4500, 5000 rpm. In certain aspects, the wet granulated mixture can be dried in the dryer 208, 308 at a temperature 40° C. to 85° C., or at least any one of, at most any one of, equal to any one of, or between any two of 40, 45, 50, 55, 60, 65, 70, 75, 80 and 85° C. In some aspects, the dryer 208, 308 can be a fluid bed dryer, drum dryer, or flash dryer. In some aspects, the wet granulated mixture can be dried in the dryer 208, 308 with an hot air flow having a flow rate of at least any one of, at most any one of, equal to any one of, or between any two of 100, 150, 200, 250, 300, 350, 400, 450, and 500 m³/hr and/or a rotation of at least any one of, at most any one of, equal to any one of, or between any two of 5, 10, 15, 20, 25, 30, 35, 40, 45, and 50 rpm.

### C. Methods of Using Fertilizer Granules

The fertilizer granule(s), composition containing the fertilizer granule(s), and fertilizer blend containing the fertilizer granule(s) of the present invention can be used in methods of increasing the amount of one or more plant nutrients in soil and of enhancing plant growth. Such methods can include applying to the soil an effective amount of a composition and/or blend containing the fertilizer granule(s) of the present invention. The method may include increasing the growth and yield of crops, trees, ornamentals, etc., such as, for example, palm, coconut, rice, wheat, corn, barley, oats, and/or soybeans. The method can include applying the fertilizer blend of the present invention to at least one of a soil, an organism, a liquid carrier, a liquid solvent, etc. The composition(s) and/or fertilizer blends(s) containing the fertilizer granule(s) can be applied to plants and/or soil as a top dressing fertilizer, basal fertilizer, and/or through any suitable method of application.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes.

The effectiveness of compositions comprising the fertilizer granule(s) of the present invention can be ascertained by measuring the amount of nitrogen and optionally other nutrients in the soil at various times after applying the fertilizer composition to the soil. It is understood that different soils have different characteristics, which can affect the stability of the nutrients in the soil. The effectiveness of a fertilizer composition can also be directly compared to other fertilizer compositions by doing a side-by-side comparison in the same soil under the same conditions.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Production and Soil and Water Dispersibility Test of Phosphogypsum Fertilizers

Materials: Phosphogypsum was received from SAFCO site. The phosphogypsum had 23.3 wt. % calcium and 18.6 wt. % sulfur. Magnesium sulfate monohydrate was obtained from Richase Enterprise Pvt Ltd. Zinc sulfate monohydrate was purchased from Thomas Baker Pvt Ltd., India. Disodium tetraborate pentahydrate was purchased from Zuari Agrochemicals Ltd. Potassium humate, calcium lignosulfate, and bentonite was purchased from local vendors in India.

Method of Production: Fertilizer granules having compositions as shown in Table 1, were prepared. Different granulation techniques and equipment were used for making the fertilizer granules of Table 1. Technique used includes, a) agglomeration (for PG-5 to PG-8), b) spray granulation (for PG-1 to PG-4, PG-9 to PG-12, PG-14, PG-16 & PG-17, PG-19 & PG-20 and PG-22), c) compaction (for PG-21 and PGG-1 to PGG-4), d) slurry granulation (for PG-13 & PG-18) and d) high-shear mixer granulation (for PG-15). Equipment used includes a) pan granulator (for PG-9 to PG-12, PG-14, PG-16 to PG-20 and PG-22), b) solid mixer (for PG-2 & PG-3), c) abrasion drum (for PG-1 and PG-4 to PG-8), mini extruder (for PG-21), high-shear mixer granulator, mycromix (for PG-15) and round bottom flask (for PG-13).

Results: Amongst twenty two formulations, PG-17 and PG-21 were found to have the best granule shape, flowability, and granulation efficiency. The PG-17 formulation was scaled up to 1 Kg and named PG-22.

TABLE 1
Formulations PG-1 to PG-22.

| Formu- | Phospho- | | | | | Batch |
|---|---|---|---|---|---|---|
| lation | gypsum | MgSO₄ | Potassium | ZnSO₄ | Borate | Size |
| No. | (%) | (%) | humate (%) | (%) | (%) | (gm) |
| PG-1 | 65 | 35 | 0 | 0 | 0 | 20 |
| PG-2 | 65 | 35 | 0 | 0 | 0 | 200 |
| PG-3 | 63 | 30 | 2 | 3 | 2 | 200 |
| PG-4 | 63 | 30 | 2 | 3 | 2 | 20 |
| PG-5 | 63 | 30 | 2 | 3 | 2 | 20 |
| PG-6 | 63 | 30 | 2 | 3 | 2 | 500 |
| PG-7 | 63 | 30 | 2 | 3 | 2 | 400 |
| PG-8 | 63 | 30 | 2 | 3 | 2 | 20 |
| PG-9 | 63 | 30 | 2 | 3 | 2 | 200 |
| PG-10 | 63 | 30 | 2 | 3 | 2 | 150 |
| PG-11 | 63 | 30 | 2 | 3 | 2 | 150 |
| PG-12 | 60 | 30 | 2 | 3 | 2 | 150 |
| PG-13 | 63 | 30 | 2 | 3 | 2 | 20 |
| PG-14 | 65 | 30 | 2 | 3 | 0 | 20 |
| PG-15 | 63 | 30 | 2 | 3 | 2 | 500 |
| PG-16 | 63 | 30 | 2 | 3 | 2 | 150 |
| PG-17 | 63 | 30 | 2 | 3 | 2 | 200 |
| PG-18 | 63 | 30 | 2 | 3 | 2 | 150 |
| PG-19 | 58 | 30 | 2 | 3 | 2 | 150 |
| PG-20 | 58 | 30 | 2 | 3 | 2 | 150 |
| PG-21 | 63 | 30 | 2 | 3 | 2 | 100 |
| PG-22 | 63 | 30 | 2 | 3 | 2 | 1000 |

Soil dispersibility test: Soil and water dispersibility test was performed for PG-22. Four pots each having 1.4 kg of soil were used. In one pot, urea (2.5 gm) was surface applied (mimicked top dressing) as a control treatment. In a second pot PG-22 (2.5 gm) was surface applied. The remaining two pots were mimicked but as basal applications, wherein 2.5 gm of PG-22 granules, for each pot, were spread ˜2 cm below soil (by removing top soil) and covered with soil. The treated pots were kept at laboratory condition under a fume hood for up to 30 days while spraying about 10 mL of water on the soil of the pots everyday (except weekends) to maintain a minimum moisture level in the soil. After 15 days, the top 2 cm of soil was removed from one of the basal treatment, photos and observations were taken, the fertilizer granules were covered again with soil and the experiment continued. After 30 days, the top 2 cm of soil was removed from both the basal treatment, and all of the pots were photographed and observed.

Water dispersibility test: 2 gms of PG-22 granules were added in a glass vial with 2 mL of water. The vile was swirled gently in a mechanical shaker for 1 min. Pictures of the sample were taken after removing from the shaker.

Results: FIG. 4A shows, surface applied (mimicked top dressing) urea granules (a), surface applied PG 22 granules (b), and basal applied PG 22 granules (c) and (d) at the day of application. FIG. 4B shows the urea granules after one day of the surface application (a), the PG-22 granules after 30 days of the surface application (b), the PG-22 granules after 30 days of basal application (c), and the PG-22 granules after 15 days of the basal application (d). Surface applied urea granules disappeared within a day; however, no significand change was observed with surface applied PG-22 after 15 days, with improved dispersibility observed after 30 days. Basal applied PG-22 granules showed good dispersibility after 15 and 30 days. FIG. 5, shows water dispersibility of the PG-22 granules. PG-22 was completely or substantially completely dispersible in water within a minute, e.g., PG-22 granules having a size of 2 to 4 mm before addition to water, disintegrated completely or substantially completely into smaller sized (e.g. less than 1 mm) particles within 1 min of addition.

### Example 2

### Fertilizer Granules Containing Phosphogypsum using Compaction Technology

Based on the results obtained for formulations PG-1 to PG-22, additional formulations PGG-1 to PGG-4, with compositions as shown in Table 2, were prepared. The raw materials, as described in Example 1, were used. To obtain granules with specific mechanical properties, a compaction granulation technique was used. FIG. 6 show a picture of granules of a reference commercial product SUL4R-PLUS® (A) and PGG-1 (B) granules, respectively.

Compact granulation method: Raw dry materials were weighted and manually fed into the mixer. Initially the materials were mixed at low concentration. The mixing process of the dry powders continued for 45 sec., and then water was added slowly into the mixer through a small opening on top. Mixing was continued for another 60 sec. and then materials were discharged from the mixer. This wet mass mixture was manually fed into the hoper which was connected to a die roller compactor granulator.

The compactor contained two rollers, which were placed side by side. These rollers were moved in counter current direction and the wet mass mixture was compressed by the rollers. The surface of one roller had desired holes to compress the material, e.g., wet mass mixture, into cylindrical strands and the surface of the other roller had a texture to push the material into the holes. Approximately 20 to 30 bar pressure was used to press the material into the holes and form cylindrical strands. A blade, which was placed inside a die roller with holes was used to cut the strands into cylindrical pellets of approximately equal length. These pellets were further processed in a spheronizer for 30 to 120 sec. to convert the cylindrical shape into spherical granules. The rate of granulation and spheronization depended on the quantity of wet mass mixture. The granulation process stability and ratio of recycling materials was dependent on the optimum content of liquid binder in the formulation. About 10 wt. % of 12 wt. % of water, based on the total weight of the raw material, was used. Water, bentonite, and calcium lignosulfonate can act as binder. A total of 300 ml water was used for PGG-1 granulations and 350 ml of water was used for granulation of each of PGG 2-4.

TABLE 2
Formulations PGG-1 to PGG-4.

| Raw | PGG-1 | | PGG-2 | | PGG-3 | | PGG-4 | |
|---|---|---|---|---|---|---|---|---|
| materials | % | Kg | % | Kg | % | Kg | % | Kg |
| Phosphogypsum | 63 | 1.89 | 62.4 | 1.872 | 58 | 1.74 | 58 | 1.74 |
| MgSO₄•H₂O | 30 | 0.9 | 30 | 0.9 | 30 | 0.9 | 30 | 0.9 |
| Potassium humate | 2 | 0.06 | 3.4 | 0.102 | 2 | 0.06 | 2 | 0.06 |
| ZnSO₄•H₂O | 3 | 0.090 | 4.2 | 0.126 | 3 | 0.09 | 3 | 0.09 |
| Disodium | 2 | 0.060 | 0 | 0 | 2 | 0.06 | 2 | 0.06 |
| tetraborate | | | | | | | | |
| pentahydrate | | | | | | | | |
| Bentonite | 0 | 0 | 0 | 0 | 5 | 0.150 | 0 | 0 |
| Calcium | 0 | 0 | 0 | 0 | 0 | 0 | 5 | 0.150 |
| lignosulfate | | | | | | | | |

Physical properties of the granular products were measured using standard protocols (e.g. from fertilizer manual).

Crush Strength Analysis: The crush strength of the granules were measured using Chatillon CS225 crush strength analyzer (Ametek, USA). Ten granules in the size range of 2 to 4 mm were taken for crush strength measurement. Each granule was placed on an immobilized platform (immobilized phase), a load cell (mobile phase) was adjusted to move down at a speed of 10 mm/min and apply force on the granule until a sharp initial crack forms on the granule surface. The load applied to make the initial crack was recorded as the crushing strength of each granule. The average crush strength of ten granules were considered as crush strength of a formulation.

Attrition Analysis: Attrition analysis was performed using Copley, FRV 2000 model (Copley Scientific, UK). A 100 cm³ portion of sieved granules in the size range of 2 to 4 mm were weighed (W1) and placed into the test drum along with 100 gm of stainless steel balls (50 Nos). The drum was closed and rotated for 10 min at 30 rpm. Then, the steel balls were separated from the sample and the material was screened over a 2 mm sieve using an electromagnetic sieve shaker. The granules over 2 mm are then re-weighed (W2). Results were calculated in terms of % weight loss using the formula:

$$Weight loss due to attrition ( wt . \% ) = \frac{weight of sample remained on 2 mm sieve}{intial weight of the sample} \times 100$$

Moisture Analysis: Moisture content in the formulations were measured using a Mettler Toledo halogen moisture analyzer, model HB43-S. The percentage of water loss in a sample was determined by measuring drying the sample at 50° C. for 25 min, and determining the loss of mass during drying.

Bulk Density (loose): 100 ml of sieved granules in the size range of 2 to 4 mm were added into a graduated measuring cylinder, transferred to a beaker, and weighed. The weight of the known volume of the sample was recorded. The bulk density was calculated as follows:

$$Bulk density = \frac{weight recorded by the sample}{known volume of the sample} ( \frac{g}{cm 3} )$$

Elemental Analysis: Ca, S, Mg, and Zn content of the granules were estimated using an X-ray fluorescence method (XRF). Boron was analyzed using ICP-OES.

Sample preparation and instrumentation for XRF: 10 g of the PGG granules were crushed into a fine powder using a pestle and mortar (˜<50 micron particle size). The powder sample was then pressed into a disc using a manual press (Herzog, Model: HSM 700H). The disc was 34 mm in diameter and 3 mm thick. XRF parameters used are shown in Table 3.

TABLE 3
XRF parameters.

| | |
|---|---|
| Crystals used: | PET, XS-55, LiF 200 |
| Detector: | flow counter and scintillation counter |
| Method used: | Quant express, standard less technique |
| Measurement mode: | Full analysis and oxide mode |

Sample preparation and instrumentation for Boron analysis: 0.2 g of powder samples in triplicate were digested using 8 mL of concentrated suprapure nitric acid in a microwave digester. The digested solutions were made up to 50 mL with milliq water and then analyzed using ICP-OES. ICP-OES parameters used are shown in Table 4.

TABLE 4
ICP-OES parameters.

| | |
|---|---|
| Microwave digester: | ULTRAclave (Milestone) |
| ICP-OES (Inductively coupled plasma | Spectro Arcos |
| optical emission spectrometer): | |
| Calibration range: | 1 ppm to 20 ppm |
| Standards used: | Merck certified standard of Boron |

Water Dispersibility: 2 gms of respective granules were add in a glass vial with 2 mL of water. The vile was swirled gently in a mechanical shaker for 1 min. Pictures of the sample were taken after removing from the shaker.

Soil Dispersibility: 2.5 grams of each sample PGG-1, PGG-2, and PGG-3, and one reference product (SUL4R-PLUS®, received from the manufacturer as a sample) were applied (separately) as basal application to pots (each) containing 1.4 Kg of soil. The samples were spread ˜2 cm below soil (by removing top soil) and covered with soil. The treated pots were then kept at laboratory condition under fume hood for up to 30 days while spraying about 10 mL of water on the soil in the pots everyday (except weekends) to maintain a minimum moisture level of the soil. After 30 days, the top 2 cm of soil was removed from all the pots and the samples were observed and photographed.

Results: Physical properties of the granules are provided in Table 5. PGG-1 to PGG-4 had good crush strength. Good crush strength of the granules may possibly be attributed to the compression granulation technique used for these granule preparations. Elemental analysis data for PGG 1-4 granules are provided in Table 6. Some deviations between obtained elemental analysis and theoretically calculated element quantity was observed. This could be due to the possibility of these products (and starting materials) containing impurities or having different degrees of hydration. For example, calcium sulfate in phosphogypsum can exist in hemihydrate and dihydrate forms.

TABLE 5
Physical properties of PGG formulations.

| | Crush strength | Moisture content | Attrition loss, | Bulk density |
|---|---|---|---|---|
| Product | (Kgf) | (%) | (%) | (g/cc) |
| PGG-1 | 2.025 ± 0.65 | 0.65 | 0.115 | 1.057 |
| PGG-2 | 3.225 ± 1.01 | 0.3 | 0.065 | 1.105 |
| PGG-3 | 2.644 ± 1.24 | 0.6 | 0.036 | 1.114 |
| PGG-4 | 4.514 ± 1.37 | 0.2 | 0.087 | 1.134 |

TABLE 6
Elemental analysis of PGG formulations

| | By XRF | | | | By ICP-OES |
|---|---|---|---|---|---|
| Formulation | Ca (%) | S (%) | Mg (%) | Zn (%) | B (%) |
| PGG-1 | 17.3 | 15.3 | 3.92 | 1.37 | 0.24 |
| PGG-2 | 16.55 | 15.65 | 4.48 | 1.83 | 0.04 |
| PGG-3 | 15.35 | 15.05 | 4.63 | 1.41 | 0.24 |
| PGG-4 | 16 | 15.45 | 4.82 | 1.42 | 0.26 |

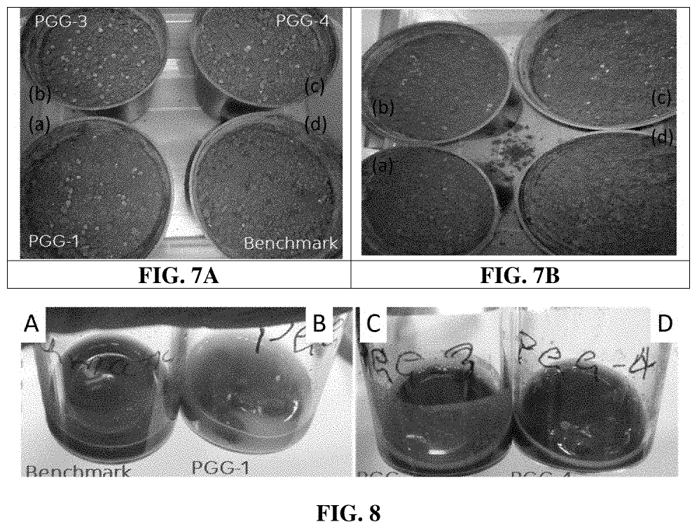

FIG. 7 shows, soil dispersibility of basal application of the PGG granules. FIG. 7A shows granules PGG-1 (a), PGG-3 (b), PGG-4 (c), and the commercial product, SUL4R-PLUS® (d) at the day of application. FIG. 7B shows PGG-1 (a), PGG-3 (b), PGG-4 (c), and SUL4R-PLUS® (d) after 30 days of application. SUL4R-PLUS® completely disappeared after 30 days, while traces of PGG granules applied to the soil can be seen, indicating more optimized dispersibility. FIG. 8 shows water dispersibility of SUL4R-PLUS® (A), PGG-1 (B), PGG-3 (C), and PGG-4 (D). PGG-3 and PGG-4 showed high dispersibility, e.g., the granules readily disintegrated into smaller sized particles, e.g. from 2 mm to 4 mm to less than 1 mm, after being added to water. Bentonite and/or calcium lignosulfonate present in the PGG-3 and PGG-4 granules respectively, may have possibly increased the dispersibility of the granules.

### Example 3

### Agronomy Tests for Phosphogypsum Containing Fertilizer Granules Produced using Compaction Technology (PGG-1, PGG-2, PGG-3 and PGG-4)

Methods: Effects of the granules, PGG-1 to PGG-4 (as produced in Example 2), on grain yield and paddy quality were studied. Study parameters used are listed in Table 7. Seven treatment experiments, with the parameters listed in Table 7 and with use of different fertilizers (Table 8) were performed. The PGG-1 (T2), PGG-2 (T3), PGG-3 (T4), PGG-4 (T5), and SUL4R-PLUS®, B+Z (T6) granules were used to provide secondary and micronutrients along with a primary nitrogen:phosphorus:potassium (NPK) nutrient. SUL4R-PLUS®, B+Z was used a reference commercial product. Control experiments, using no fertilizers (T0), and primary fertilizer only (T1) were also performed. For the respective experiments, 0.5 kg of granules (e.g. PGG-1 in T2, PGG-2 in T3, PGG-3 in T4, PGG-4 in T5, and SUL4R-PLUS® in T6) per 20 m² plot were applied. Primary fertilizer (NPK) dose used, for experiments T1-T6, was in accordance with local government (Tamil Nadu, India) agricultural department guidelines.

TABLE 7
Study Parameters

| | |
|---|---|
| Crop & Variety | Paddy (Oryza sativa L.), ADT-43 |
| Season & Duration | Summer, January-April 2020 |
| Location | International Institute of Biotechnology And |
| | Toxicology (IIBAT), Padappai, Tamil Nadu, |
| | India |
| Plot size & Replicates | 20 m² (5 m × 4 m), Three replicates, Open |
| | field trial |
| Soil Type | Sandy clay loam soil |
| Harvest parameters | Crop yield, shoot yield, and other standard |
| | parameters |

TABLE 8
Treatment Experiments

| Treatment | Fertilizer/Product | |
|---|---|---|
| Exp. No. | Treatment | Comments |
| T0 | Control: No Fertilizer | |
| T1 | Control: Recommended | Recommended NPK dose by |
| | dose fertilizer (RDF) | local government agricultural |
| | | department |
| T2 | PGG-1 + RDF | PGG-1 to PGG-4 & SUL4R- |
| T3 | PGG-2 + RDF | PLUS ®, B + Z products—0.5 kg |
| T4 | PGG-3 + RDF | per 20 m² plot applied |
| T5 | PGG-4 + RDF | |
| T6 | Reference commercial | |
| | product (SUL4R-PLUS ®, | |
| | B + Z) + RDF | |

Results: PGG-1 treatment (T2) provided the best grain yield, 13.4% increase in grain yield, when compared with application of recommended doses of NPK fertilizers (see Table 9). In comparison, SUL4R-PLUS® B+Z gave 12.8% increase in grain yield. Cost to benefit ratio of 4.62 was obtained for PGG-1 treatment. PGG-1 treatment (T2) also resulted in a straw yield increase of 19.6%.

Highest plant growth parameters (e.g. plant height, number of tillers per hill, panicles per hill, and panicle length), were obtained for treatment with SUL4R-PLUS® B+Z followed by PGG-1.

TABLE 9
Grain yield for the treatment experiments.

| Treatment | *Grain yield | % Grain yield increase |
|---|---|---|
| Exp. No. | (Kg/20 mtr Plot) | over T1 |
| T0 | 8.20^{a} | NA |
| T1 | 14.9^{b} | NA |
| T2 | 16.9^{c} | 13.42 |
| T3 | 16.1^{c} | 8.05 |
| T4 | 16.4^{c} | 10.07 |
| T5 | 16.6^{c} | 11.41 |
| T6 | 16.8^{c} | 12.75 |

*Mean of three replicates;
Mean followed by similar letter are not significantly different
% increase over T0 (Control) = (Treatment − T0)/T0) × 100
% increase over T1 (NPK Only) = (Treatments − T1)/T1) × 100
The differences among treatment means were separated employing a least significant difference test (LSD)
LSD (p = 0.05), 1.17

1. A fertilizer granule comprising a homogeneous mixture comprising:
phosphogypsum in an amount providing 6.5 wt. % to 22 wt. % of calcium (Ca) and 5 wt. % to 17.6 wt. % sulfur (S) present in the form of sulfate;
3.8 wt. % to 8 wt. % of magnesium (Mg);
0.5 wt. % to 4 wt. % of zinc (Zn);
additional sulfate in an amount providing an additional 5 to 12.5 wt. % of sulfur (S); and
optionally 0.5 wt. % to 5 wt. % of a humic substance,
wherein the wt. % are based on the total weight of the fertilizer granule.

2. The fertilizer granule of claim 1, further comprising 0.1 wt. % to 1 wt. % of boron (B).

3. The fertilizer granule of claim 1, further comprising 2 wt. % to 10 wt. % of a binder.

4. The fertilizer granule of claim 3, wherein the binder is calcium lignosulfate and/or bentonite.

5. The fertilizer granule of claim 1, wherein the humic substance comprises humic acid and/or a humate salt.

6. The fertilizer granule of claim 1, wherein the Mg is sourced as a water soluble magnesium sulfate and/or the Zn is sourced as a water soluble zinc sulfate.

7. The fertilizer granule of claim 2, wherein the B is sourced as a water soluble tetraborate and/or tetraborate salt.

8. The fertilizer granule of claim 1, comprising a moles of Ca, b moles of Mg, c of moles Zn, and d moles of S, wherein d is≥0.9×(a+b+c) and a, b, c, and d are real numbers.

9. The fertilizer granule of claim 2, comprising 15 wt. % to 20 wt. % of calcium (Ca); 3.8 wt. % to 5 wt. % of magnesium (Mg); 0.5 wt. % to 2.5 wt. % of zinc (Zn); 13 wt. % to 20 wt. % of sulfur (S); 0.5 to 3 wt. % of a humic substance; and 0.1 wt. % to 0.4 wt. % of B.

10. The fertilizer granule of claim 1, comprising 14 wt. % to 19 wt. % of calcium (Ca); 4 wt. % to 6 wt. % of magnesium (Mg); 1 wt. % to 3 wt. % of zinc (Zn); 13 wt. % to 20 wt. % of sulfur (S); and 1.5 to 4 wt. % of a humic substance.

11. The fertilizer granule of claim 2, comprising 13 wt. % to 19 wt. % of calcium (Ca); 4 wt. % to 6 wt. % of magnesium (Mg); 0.5 wt. % to 2.5 wt. % of zinc (Zn); 13 wt. % to 20 wt. % of sulfur (S); 0.1 wt. % to 0.4 wt. % of B; 0.5 wt. % to 3 wt. % of a humic substance; and either 3 wt. % to 7 wt. % of bentonite, or 3 wt. % to 7 wt. % of calcium lignosulfate, or both 3 wt. % to 7 wt. % of bentonite and 3 wt. % to 7 wt. % of calcium lignosulfate.

12. The fertilizer granule of claim 1, wherein 10 mg to 30 mg of the fertilizer granules dissolves in 1 ml of water at a pH 7, under stirring at a rate 90 rpm to 110 rpm, and at an ambient temperature, within 5 minutes of adding 100 mg of the fertilizer granules to the water.

13. The fertilizer granule of claim 1, having a moisture content of less than 1 wt. % measured at 50° C.

14. The fertilizer granule of claim 1, having a crush strength above 1.8 kgf.

15. The fertilizer granule of claim 1, capable of losing less than 0.13 wt. % in an attrition loss test.

16. The fertilizer granule of claim 1, wherein the granules have a bulk density of 1 g/cc to 1.2 g/cc.

17. The fertilizer granule of claim 1, comprised in a fertilizer blend comprising the fertilizer granule and an additional fertilizer comprising urea, diammonium phosphate (DAP), single super phosphate (SSP), triple super phosphate (TSP), muriate of potash (MOP), ammonium sulfate, or any combinations thereof.

18. A method for making the fertilizer granule of claim 1, the method comprising:
contacting a feed mixture with water and granulating the feed mixture to form a wet granulated mixture, wherein the feed mixture comprises Ca, Mg, Zn, sulfate, and optionally B, optionally humic acid, and optionally a binder; and
drying the wet granulated mixture to form a dry granulated mixture comprising the fertilizer granule.

19. The method of claim 18, wherein the feed mixture is granulated by compaction.

20. The method of claim 18, further comprising:
passing the wet granulated mixture, prior to drying, through one or more size screens to separate granules having a size smaller and/or bigger than a desired size; and
recycling at least a portion of the separated granules to the granulation step.
